(19) United States
(12) Patent Application Publication
(10) Pub. No.: US 2025/0145116 A1
(43) Pub. Date: May 8, 2025

(54) DEBRIS MANAGEMENT SLIDER

(71) Applicant: International Truck Intellectual Property Company, LLC, Lisle, IL (US)

(72) Inventors: Robert M. Tourville, Aurora, IL (US); Michael John Muff, Plainfield, IL (US)

(73) Assignee: International Truck Intellectual Property Company, LLC, Lisle, IL (US)

(21) Appl. No.: 18/387,262

(22) Filed: Nov. 6, 2023

(51) Int. Cl. B60S 1/08; B60S 1/04; B60S 1/34

(52) U.S. Cl. CPC B60S 1/0862; B60S 1/0425; B60S 1/3406

(57) ABSTRACT

A debris management system includes a slider adapted to move in first and second directions along a track disposed across a vehicle surface. The slider has a first side facing the first direction, a second side facing the second direction, and a spray barrier disposed along each of the first and second sides. A wiper mechanism extends from the slider and is adapted to make contact with the vehicle surface.

### FIELD OF THE INVENTION

The present disclosure relates generally to a debris management system for cleaning debris blocking the field of view of vehicle mounted sensors, and more particularly to such a debris management system having a slider that moves along a track disposed on a vehicle surface.

### BACKGROUND

Sensors are being disposed on surfaces of modern vehicles in ever increasing numbers. Such sensors are distributed all around a vehicle for collecting data on the vehicle surroundings in all directions for use in critical tasks, for example, including autonomous driving modes. It is crucial that such sensors function accurately without being fouled by debris blocking the field of view of the sensor. A need therefore exists for a robust and reliable cleaning system that can clean the field of view of vehicle mounted sensors in any driving environment. It would be useful if such a cleaning system could operate to clean the field of view of one or more sensors as needed.

### SUMMARY OF THE INVENTION

In one aspect of the invention, a debris management system comprises a slider adapted to move in first and second directions along a track disposed across a vehicle surface, the slider comprising a first side facing the first direction, a second side facing the second direction, and a spray barrier disposed along each of the first and second sides. A wiper mechanism extends from the slider and is adapted to make contact with the vehicle surface.

In another aspect of the invention, a debris management system comprises a track disposed across a vehicle surface, and a slider adapted to move in first and second directions along the track, wherein the slider comprises a first side facing the first direction, a second side facing the second direction, and a spray barrier disposed along each of the first and second sides. One or more sensors is embedded within the vehicle surface proximate to the track, wherein each sensor has a field of view facing outwardly through the vehicle surface, wherein the vehicle surface is transparent to the field of view of each sensor. A wiper mechanism extends from the slider and is adapted to make contact with the vehicle surface.

In a further aspect of the invention, a debris management system comprises a track disposed across a vehicle surface, and a slider adapted to move in first and second directions along the track. The slider comprises a first side facing the first direction, a second side facing the second direction, and a spray barrier disposed along each of the first and second sides, a fluid reservoir, and a pump operationally connected to a nozzle adapted to spray fluid from the fluid reservoir onto the vehicle surface. One or more sensors is embedded within the vehicle surface proximate to the track, wherein each sensor has a field of view facing outwardly through the vehicle surface, and wherein the vehicle surface is transparent to the field of view of each sensor. A calibration box is disposed on a surface of the slider facing the vehicle surface, and a wiper mechanism extends from the slider and is adapted to make contact with the vehicle surface.

### BRIEF DESCRIPTION OF THE DRAWINGS

The foregoing and other features of the present disclosure will become more fully apparent from the following description and appended claims, taken in conjunction with the accompanying drawings. These drawings depict only several embodiments in accordance with the disclosure and are, therefore, not to be considered limiting of its scope.

FIG. 1 is a schematic diagram of an exemplary debris management system according to an embodiment;

FIG. 2 is a schematic diagram of a portion of the exemplary debris management system shown in FIG. 1 according to an embodiment;

FIG. 3 is a schematic diagram of a side view of an exemplary slider according to an embodiment;

FIG. 4 is a schematic diagram of an exemplary slider having a pivoting wiper mechanism according to an embodiment;

FIG. 5 is a schematic diagram of an exemplary slider having a translating wiper mechanism according to an embodiment;

FIG. 6 is a schematic diagram of a side of an exemplary slider as seen from a sensor according to an embodiment;

FIG. 7A is a schematic diagram of an exemplary first image acquired by a sensor; and

FIG. 7B is a schematic diagram of an exemplary second image acquired by the sensor for use in comparison with the first image shown in FIG. 7A.

In the following detailed description, various embodiments are described with reference to the appended drawings. The skilled person will understand that the accompanying drawings are schematic and simplified for clarity. Like reference numerals refer to like elements or components throughout. Like elements or components will therefore not necessarily be described in detail with respect to each figure.

### DETAILED DESCRIPTION

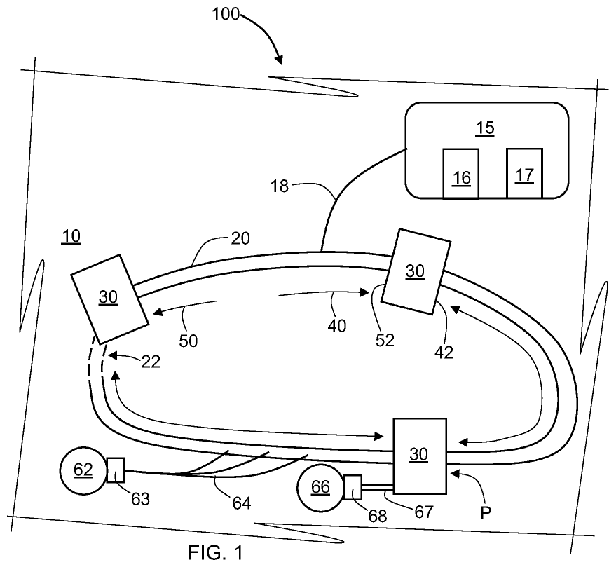

Referring to FIG. 1, an exemplary vehicle surface 10 is purposely shown having indefinite boundaries indicative of being part of a larger surface. In an embodiment, a debris management system (DMS) 100 includes a track 20 disposed across the vehicle surface 10. In an embodiment, the track 20 can be a single track or groove or rib or can be two or more parallel tracks or grooves or ribs as illustrated in FIG. 1. In various embodiments, the track 20 is linear, or curvilinear, or a closed shape as indicated by the dashed portion 22 of the track 20. In an embodiment, the DMS 100 includes a slider 30, which is illustrated in three different positions in FIG. 1, and is adapted to move along the track 20 in first 40 and second 50 directions.

In an embodiment, the DMS 100 includes a processor or computer 15 that controls the operations of and movements of the components of the DMS 100. In an embodiment, the processor 15 includes a user interface 16, that, for example without limitation, includes a keyboard, touchscreen, or other tactile, visual, or audio interface (not shown) allowing a user to enter commands into the processor 15. The processor 15 is in communication via a wired connection 18 or via a wireless communication protocol as is known in the art with all of the elements of the DMS 100 described hereinabove and hereinbelow, including, for example, the track 20, the sensors 60, nozzles 47, pumps 63 and 68, the slider 30, and components that are on or part of the slider 30 including the pump 69 and the wiper mechanism 75, 77.

In an embodiment, the processor 15 includes a data storage memory 17, in communication with the processor 15 and the sensors 60, for example, disposed within the DMS 100, elsewhere within the vehicle on which the DMS 100 is installed, or remote from the vehicle and accessible by the processor and sensors 60 via a network as is known in the art. In an embodiment the data storage memory 17 comprises non-volatile memory that stores software or firmware loaded and executed by the processor 15 during operation.

In an embodiment, the DMS 100 includes at least four operational modes for the slider, wherein the slider 30 is parked, wherein the slider 30 moves to and covers a particular target sensor 60 for cleaning, wherein the slider 30 moves to and covers a particular target sensor 60 for calibration or measurement, and wherein the slider 30 moves continuously along the track 20. The mode of operation for the slider 30 is controlled by the processor 15 and can be the result of input from a user, from one or more of the sensors 60, or based on a timed interval for cleaning, calibration, or measurement, as predetermined by the processor 15.

In an embodiment, the DMS 100 also includes at least diagnostic, active data acquisition, and calibration modes for each of the sensors 60. For example, the data acquisition mode can be considered to be active any time that one or more of the sensors 60 is being used to acquire data for the vehicle. The DMS 100, in an embodiment, can also apply a diagnostic mode to each sensor 60 to check it for baseline functioning, malfunctioning, or partial or total blockage. In an embodiment, the diagnostic mode can be executed concurrently with the active data acquisition mode, or as part of the active data acquisition mode, so that an alarm or indication of a non-optimal condition of a sensor 60 is immediately discovered by the DMS 100. In an embodiment, the DMA 100 also includes a calibration and measurement mode as applied to each sensor 60 as is further described below.

In an embodiment, in addition to commanding the operations of the DMS 100, the processor 15 continuously tracks the position of the slider 30 relative to the track 20 and each of the sensors 60. This positional tracking is important to all phases of operation for the slider 30 including being parked, moving to a particular sensor 60, and moving continuously along the track 20. For example, in an operational mode where the slider 30 is being moved continuously along the track 20, the position of the slider 30 must be known by the DMS 100 relative to all of the sensors 60 to account for any interruption of the field of view, F, of any of the sensors 60 over which the slider 30 passes. Otherwise, such interruptions of the field of view, F, of any sensor 60 could be interpreted as a failure or total blockage of the sensor 60.

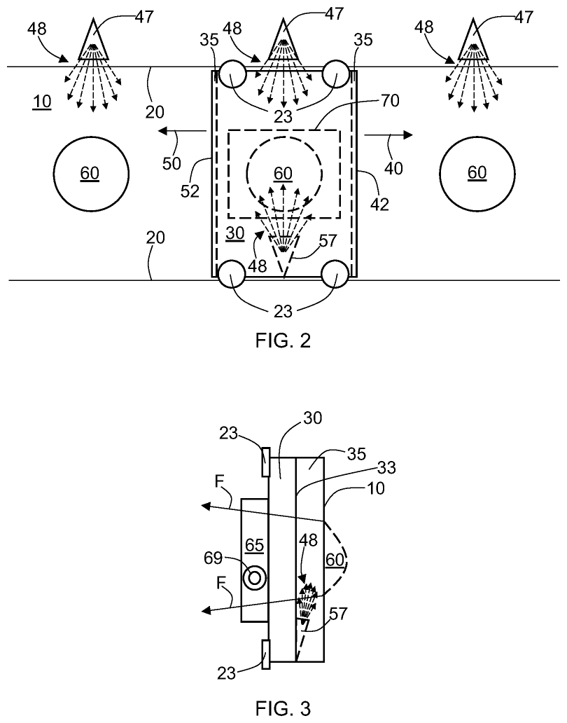

Referring now to FIGS. 1 and 2, in an embodiment, the slider 30 comprises a first side 42 facing the first direction 40, and a second side 52 facing the second direction 50. In an embodiment, the slider 30 moves along the track 20, for example, via wheels or gears 23 or another mechanism for propulsion as is known in the art. In an embodiment, the wheels or gears 23 or other mechanism for propulsion, or a tab or brush (not shown) extending from the slider 30 into contact with the track 20, provides a path for electrical communication between the track 20 and the slider 30. In an embodiment, one or more sensors 60 are embedded within the vehicle surface 10 proximate to the track 20.

Referring to FIG. 3, in an embodiment, each sensor 60 has a field of view, for example illustrated by the arrows F in FIG. 3, facing outwardly through the vehicle surface 10, wherein the vehicle surface 10 is transparent to the field of view F of each sensor 60. It should be noted that the field of view, F, although shown in two dimensions on FIG. 3 is actually three-dimensional, extending into and out of the plane of the paper to have a roughly cylindrical or frustoconical shape that extends from each sensor 60. In an embodiment, each of the one or more sensors 60 is selected from the group of sensors consisting of an optical sensor, a light direction and ranging (LIDAR) sensor, a radio detection and ranging (RADAR) sensor, an infrared sensor, and a sonic sensor. Without being held to theory, in all embodiments herein the vehicle surface 10 is made from a material that is transparent to the field of view F of the one or more sensors 60.

In an embodiment, the slider 30 is configured to move to and cover the field of view F of at least one of the one or more sensors 60. In an embodiment, a nozzle 47 extends from the vehicle surface 10 proximate to each sensor 60 (see FIG. 2), wherein the nozzle 47 is adapted to spray fluid, represented by the group of dashed arrows 48, onto the vehicle surface 10 in the field of view F. In this embodiment, the nozzles 47 are supplied from a main reservoir 62, via a pump 63 and supply lines 64 embedded in the vehicle surface 10 (see FIG. 1).

Referring to FIGS. 2 and 3, in an embodiment, instead of the nozzles 47 extending from the vehicle surface 10, the slider 30 itself includes a nozzle 57 disposed thereon, for example on a side of the slider 30 facing the vehicle surface 10. In an embodiment, of the DMS 100 the slider 30 further includes a fluid reservoir 65 and a pump 69 operationally connected to the nozzle 57. The fluid reservoir 65 and the pump 69 are shown in FIG. 3 but omitted from FIG. 2 for clarity. The nozzle 57 is adapted to spray fluid 48 from the fluid reservoir 65 onto the vehicle surface 10. In an embodiment, when the slider 30 is positioned to cover the field of view F of at least one of the one or more sensors 60, the nozzle 57 is configured to spray the fluid 48 onto the vehicle surface 10 in the field of view F of the at least one of the one or more sensors 60. Without being held to theory, including a nozzle 57, a fluid reservoir 65, and a pump 69 on the slider 30 can eliminate problems with loss of fluid pressure caused by moving fluid over larger distances as associated with the main reservoir 62, the pump 63, and the nozzles 47.

Referring now to FIGS. 2 and 3, in an embodiment, the slider 30 further comprises a spray barrier 35 disposed along each of the first 42 and second 52 sides. In an embodiment, each spray barrier 35 extends from a side 33 of the slider 30 facing the vehicle surface 10 and into contact with the vehicle surface 10. Without being held to theory each spray barrier 35 is made from a material including, for example, rubber, and inhibits fluid 48 sprayed from nozzles 47, 57 from impinging on portions of the vehicle surface 10 other than an intended region. For example, in an embodiment, each spray barrier 35 inhibits spray from impinging on the vehicle surface 10 over sensors 60 adjacent to an intended region of the vehicle surface 10 over a targeted sensor 60.

In an embodiment, the slider 30 is configured to move continuously along the track 20, for example, in a continuous looping path around a looped track 20 or in a back-and-forth continuous motion along a non-looped track 20. For example, the slider 30 can move continuously along the track 20 if there is consistent debris, like rain, present and fouling the sensors 60. As in an embodiment wherein the slider 30 moves to and covers a particular sensor, the DMS 100, the position of the slider 30 is continuously tracked by the processor 15. In an embodiment wherein the slider 30 is configured to move continuously along the track 20, the nozzle 57 or the nozzles 47 spray fluid onto the vehicle surface 10. In another embodiment wherein the slider 30 is configured to move continuously along the track 20, the nozzle 57 or the nozzles 47 do not spray fluid onto the vehicle surface 10. In an embodiment wherein the slider 30 is configured to move continuously along the track 20, the spray barriers 35 additionally function to wipe the vehicle surface 10 as the slider 30 moves.

In an embodiment of the DMS 100 the slider 30 includes a parked position, for example, position P in FIG. 1, on the track 20 outside of the field of view F of any of the one or more sensors 60. In an embodiment, the fluid reservoir 65 is filled with fluid from a main reservoir 66 when the slider 30 is in the parked position P. In an embodiment, the filling of the fluid reservoir 65 is facilitated by pump 68 disposed between the main reservoir 66 and a connector tube 67 that includes, for example, a quick connector mechanism (not shown) that actuates in combination with the slider 30 moving toward the main reservoir 66 to engage the quick connector and that actuates in combination with the slider 30 moving away from the main reservoir 66 to disengage the quick connector. In an embodiment, the processor 15 communicates with and controls actuation of the quick connector (not shown) when moving the slider 30 into or out of engagement with the pump 68. In other embodiments, other mechanisms for filling the fluid reservoir 65 can be applied as are known in the art.

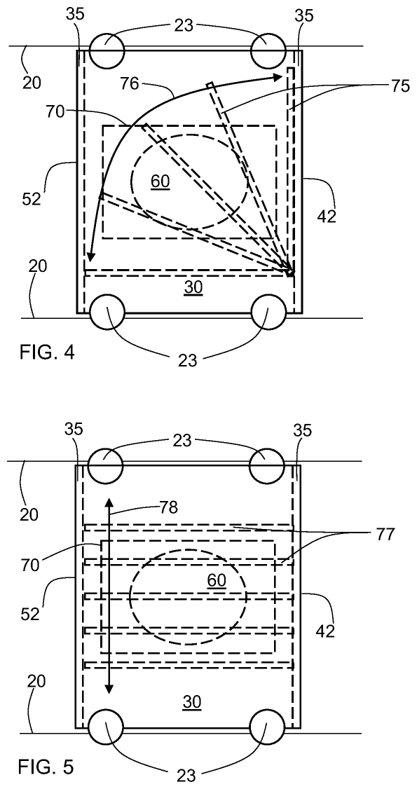

Referring to FIGS. 4 and 5, in an embodiment, a wiper mechanism 75, 77 shown in dashed lines because it is on a side of the slider 30 opposite the viewer, extends from the slider 30 and is adapted to make contact with the vehicle surface 10 to wipe the field of view F of the sensor 60 over which the slider 30 is positioned. In an embodiment, the wiper mechanism 75 comprises a wiper 75 that pivots through an arc 76 as shown in FIG. 4, and is configured to wipe the vehicle surface 10 in the field of view F of the sensor 60. In an embodiment, a wiper mechanism 77 comprises a wiper 77 that translates back and forth indicated by arrow 78 transverse to the wiper 77 as shown in FIG. 5, and is configured to wipe the vehicle surface 10 in the field of view F of the sensor 60.

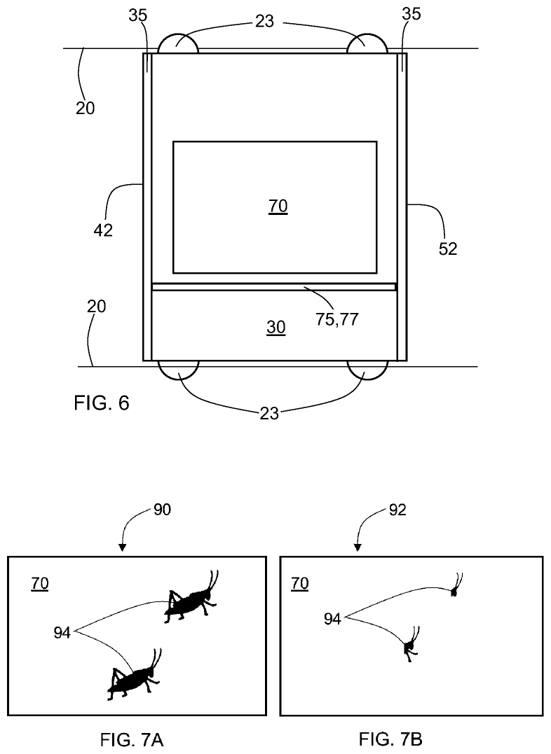

Referring to FIGS. 2 and 4-6, in an embodiment, the slider 30 further comprises a calibration box 70 disposed on a surface of the slider 30 facing the vehicle surface 10 and within the field of view F of the sensor 60 over which the slider 30 is positioned. Referring to FIG. 6, in an embodiment, the side of the slider 30 facing the vehicle surface 10 is shown as seen by the sensor 60 over which the slider 30 is positioned. In this position the calibration box 70 blocks the field of view F of the sensor 60. In an embodiment, the calibration box 70 has a featureless surface, for example, a plain white surface.

Referring to FIGS. 7A and 7B, a method for measuring cleaning efficiency of the DMS 100, begins with moving the slider 30 to cover the field of view F of a sensor 60 with the calibration box 70. This operation can be initiated by the processor 15 based on a timed interval, can be manually triggered by a user input, or can be the result of a diagnostic of the sensor 60 indicating for any reason that it the sensor 60 is not functioning correctly. With the calibration box 70 positioned in the field of view F, a first image 90 of the calibration box 70 as shown in FIG. 7A is acquired using the sensor 60. Debris 94 on the surface of the vehicle 10 in the field of view F of the sensor 60 is captured in the first image 90, for example as the crickets illustrated. In a subsequent step the first image 90 is saved to the data storage memory 17. Subsequent to saving the first image 90 the vehicle surface 10 in the field of view F of the sensor 60 is sprayed with fluid 48 from the nozzle(s) 47, 57 and wiped with the wiper mechanism 75, 77. After the vehicle surface 10 has been cleaned by being sprayed and wiped, a second image 92 of the calibration box 70 as shown in FIG. 7B is acquired using the sensor 60, and optionally also saved to the data storage memory 17. If the cleaning was effective, the debris 94 remaining on the surface of the vehicle 10 and captured in the second image 92 should be diminished in comparison to the debris 94 in the first image 90.

In an embodiment, a measure of cleaning efficiency can be formulated based on the amount of debris 94 remaining in the second image 92 as compared to the amount of debris captured in the first image 90. For example, in an embodiment, a first area A1 fouled by the debris 94 in the first image 90 is measured and compared to a second area A2 fouled by the debris 94 in the second image 92. A measure of cleaning efficiency based on a difference between the first and second areas A1 and A2 can be formulated.

In an embodiment, a measure of the cleaning efficiency for a sensor 60 using the calibration box 70 can be based on comparison of grey scale value images based on the amount of debris 94 remaining in the second image 92 as compared to the amount of debris captured in the first image 90. In such a process the first image 90 is changed to a black and white image and compared to a stored image of the calibration box 70, which is a featureless plain white surface. The grey scale acquired image will be white if it matches the calibration mark 70, which is indicative of no debris fouling the sensor 60. However, as debris is built up over the sensor 60, the grey scale acquired image will turn grey or black. A numerical value for the amount of debris as indicated by grey or black areas can be computed for each grey scale acquired image, thus establishing a numerical measure for quantifying whether the surface of the vehicle 10 over the sensor 60 is clean or dirty as further explained below. The difference, or the percent difference, between the numerical values so computed from the before cleaning grey scale acquired image and the after cleaning grey scale acquired image provides a measure of the cleaning efficiency of a cleaning cycle. The results of the before and after cleaning comparisons also provide data on how efficient a cleaning cycle is, and if there is improvement in repeating a cleaning cycle. If no improvement is made after repeating the cleaning cycle, then other appropriate corrective action, for example, an alarm or a request for a manual intervention, can be made.

In an embodiment, the surface of the vehicle 10 over a sensor 60 can be considered to be clean even if it is not 100% free of debris. For example, in an embodiment, a criterion for determining whether the surface of the vehicle 10 over the sensor 60 is clean or dirty utilizes the above-described method. In an embodiment, when the surface of the vehicle 10 over the sensor 60 is known to be sufficiently clean so that the sensor 60 is functioning normally, the sensor 60 can be considered by the DMS 100 to have clean status. In an embodiment, a first image of the sensor 60 having clean status (hereinafter “a clean image”) is acquired with the calibration box 70 covering the field of view F of the sensor 60. The numerical value for the amount of debris as indicated by grey or black areas (as described above) is computed for a grey scale converted image of the clean image. Thus, a quantitative numerical measure is established and stored within the data storage memory 17 of the DMS 100 for determining whether the surface of the vehicle 10 over the sensor 60 is clean or dirty. The quantitative numerical measure can be used as a baseline for subsequent determinations of whether or not the surface of the vehicle 10 over the sensor 60 has clean status. Alternatively, the quantitative numerical value for establishing a clean status can be pre-determined and stored within the data storage memory 17 of the DMS 100.

Subsequent determinations of clean or dirty status for a sensor 60 can then be made by comparing the quantitative numerical value computed for the clean image with a quantitative numerical value computed in the same way for a subsequently acquired image. If the quantitative numerical value computed for the subsequently acquired image is indicative of the same or less debris as for the clean image, then the sensor 60 is considered by the DMS 100 to have a clean status.

With respect to the use of plural and/or singular terms herein, those having skill in the art can translate from the plural to the singular and/or from the singular to the plural as is appropriate to the context and/or application. The various singular/plural permutations may be expressly set forth herein for sake of clarity. Unless otherwise noted, the use of the words “approximate,” “about,” “around,” “substantially,” etc., mean plus or minus ten percent.

### INDUSTRIAL APPLICABILITY

A debris management system comprises a slider that moves along a track to clean the fields of view of sensors disposed along the track. The system includes a calibration box for measuring the cleaning efficiency of the system. The system can be manufactured in industry for use on vehicles purchased by consumers.

Numerous modifications to the present invention will be apparent to those skilled in the art in view of the foregoing description. It is not desired to limit the invention to the exact construction and operation shown and described, and accordingly, all suitable modifications and equivalents may be resorted to, falling within the scope of the invention. Accordingly, this description is to be construed as illustrative only of the principles of the invention and is presented for the purpose of enabling those skilled in the art to make and use the invention and to teach the best mode of carrying out same. The exclusive rights to all modifications which come within the scope of the appended claims are reserved. All patents, patent publications and applications, and other references cited herein are incorporated by reference herein in their entirety.

We claim:

1. A debris management system comprising:
a slider adapted to move in first and second directions along a track disposed across a vehicle surface, the slider comprising a first side facing the first direction, a second side facing the second direction, and a spray barrier disposed along each of the first and second sides; and
a wiper mechanism that extends from the slider and is adapted to make contact with the vehicle surface.

2. The debris management system of claim 1, further comprising the track, wherein one or more sensors are embedded within the vehicle surface proximate to the track, and wherein each sensor has a field of view facing outwardly through the vehicle surface, wherein the vehicle surface is transparent to the field of view of each sensor.

3. The debris management system of claim 2, wherein the slider is configured to move continuously along the track.

4. The debris management system of claim 2, wherein the slider is configured to move to and cover the field of view of at least one of the one or more sensors.

5. The debris management system of claim 4, wherein a nozzle extends from the vehicle surface proximate to each sensor, wherein the nozzle is adapted to spray fluid onto the vehicle surface in the field of view.

6. The debris management system of claim 4, wherein the slider further comprises a calibration box disposed on a surface within the field of view and facing the at least one of the one or more sensors.

7. The debris management system of claim 4, wherein the slider includes a fluid reservoir and a pump operationally connected to a nozzle adapted to spray fluid from the fluid reservoir onto the vehicle surface.

8. The debris management system of claim 7, wherein when positioned to cover the field of view of the at least one of the one or more sensors, the nozzle is configured to spray the fluid onto the vehicle surface in the field of view.

9. The debris management system of claim 8, wherein the wiper mechanism comprises a wiper that pivots through an arc, and is configured to wipe the vehicle surface in the field of view.

10. The debris management system of claim 8, wherein the wiper mechanism comprises a wiper that translates in a direction transverse to the wiper, and is configured to wipe the vehicle surface in the field of view.

11. The debris management system of claim 2, wherein the slider includes a parked position on the track outside of the field of view of any of the one or more sensors, and wherein a fluid reservoir is filled with fluid from a main reservoir when the slider is in the parked position.

12. A debris management system comprising:
a track disposed across a vehicle surface;
a slider adapted to move in first and second directions along the track, the slider comprising a first side facing the first direction, a second side facing the second direction, and a spray barrier disposed along each of the first and second sides;
one or more sensors embedded within the vehicle surface proximate to the track, wherein each sensor has a field of view facing outwardly through the vehicle surface, wherein the vehicle surface is transparent to the field of view of each sensor; and
a wiper mechanism that extends from the slider and is adapted to make contact with the vehicle surface.

13. The debris management system of claim 12, wherein the slider includes a fluid reservoir and a pump operationally connected to a nozzle adapted to spray fluid from the fluid reservoir onto the vehicle surface.

14. The debris management system of claim 13, wherein the slider is configured to move to and cover the field of view of at least one of the one or more sensors, and wherein when the slider is positioned to cover the field of view of the at least one of the one or more sensors, the nozzle is configured to spray the fluid onto the vehicle surface in the field of view.

15. The debris management system of claim 14, wherein the wiper mechanism is selected from a group consisting of a wiper that pivots through an arc and is configured to wipe the vehicle surface in the field of view, and a wiper that translates in a direction transverse to the wiper and is configured to wipe the vehicle surface in the field of view.

16. The debris management system of claim 12, wherein the slider is configured to move continuously along the track.

17. A debris management system comprising:
a track disposed across a vehicle surface;
a slider adapted to move in first and second directions along the track;
the slider comprising:
a first side facing the first direction, a second side facing the second direction, and a spray barrier disposed along each of the first and second sides;
a fluid reservoir; and
a pump operationally connected to a nozzle adapted to spray fluid from the fluid reservoir onto the vehicle surface;
one or more sensors embedded within the vehicle surface proximate to the track, wherein each sensor has a field of view facing outwardly through the vehicle surface, wherein the vehicle surface is transparent to the field of view of each sensor;
a calibration box disposed on a surface of the slider facing the vehicle surface; and
a wiper mechanism that extends from the slider and is adapted to make contact with the vehicle surface.

18. The debris management system of claim 17, wherein the slider is configured to move to and cover the field of view of at least one of the one or more sensors, and wherein when the slider is positioned to cover the field of view of the at least one of the one or more sensors, the nozzle is configured to spray the fluid onto the vehicle surface in the field of view.

19. The debris management system of claim 18, wherein the wiper mechanism is selected from a group consisting of a wiper that pivots through an arc and is configured to wipe the vehicle surface in the field of view, and a wiper that translates in a direction transverse to the wiper and is configured to wipe the vehicle surface in the field of view.

20. A method for measuring cleaning efficiency of the debris management system of claim 19, wherein the method comprises the steps of:
moving the slider to cover the field of view of at least one of the one or more sensors with the calibration box;
acquiring a first image of the calibration box with the at least one of the one or more sensors;
saving the first image to memory;
cleaning the vehicle surface in the field of view by spraying fluid from the nozzle onto the vehicle surface in the field of view and wiping the vehicle surface with the wiper mechanism; and
acquiring a second image of the calibration box with the at least one of the one or more sensors;
comparing a first area fouled by debris in the first image to a second area fouled by debris in the second image, and formulating a measure of cleaning efficiency based on the first and second areas.
